(19) United States
(12) Patent Application Publication
(10) Pub. No.: US 2016/0180266 A1
(43) Pub. Date: Jun. 23, 2016

(54) USING SOCIAL MEDIA FOR IMPROVING SUPPLY CHAIN PERFORMANCE

(71) Applicant: Tata Consultancy Services Limited, Mumbai (IN)

(72) Inventors: Suba PALANI, Bangalore (IN); Avneet SAXENA, Bangalore (IN); Rajarajan Ramalingam THANGAVEL, Bangalore (IN)

(21) Appl. No.: 14/624,932

(22) Filed: Feb. 18, 2015

(30) Foreign Application Priority Data
Dec. 19, 2014 (IN) 4097/MUM/2014

(51) Int. Cl. G06Q 10/06

(52) U.S. Cl. CPC G06Q 10/0637; G06Q 10/06393; G06Q 50/01

(57) ABSTRACT

Disclosed is a method and system for processing posts retrieved from social media to improve performance of a supply chain of products and services. The system may collect posts of users from social media and may classify the posts into a plurality of categories. The system may determine an opinion of the users based upon the classified posts. The system may then calculate the latent variables for the supply chain. Further, the system may calculate modified Key Performance Indicators (KPI's) of the supply chain based on existing KPI's of the supply chain, the opinion of the users, and the latent variables. Subsequently, the system may manage supply chain enablers of the products and the services based on the modified KPI's.

### CROSS-REFERENCE TO RELATED APPLICATION AND PRIORITY

The present application claims priority from an Indian Patent Application No. 4097/MUM/2014 filed on Dec. 19, 2014.

### TECHNICAL FIELD

The present disclosure, in general, relates to processing posts retrieved from social media. Specifically, the present subject matter is related to processing posts retrieved from social media to improve performance of a supply chain of products and services.

### BACKGROUND

Generally a supply chain of products and services begin from a manufacturer and/or a service provider and ends while the products and the services reach a consumer. Retailers and distributors play a role of middlemen by buying the products and the services from the manufacturers in bulk and then selling the products and services to the consumers. Thus, the retailers and the distributors play an essential role in maintaining the supply chain.

It is a tedious task to manage the supply chain of the products and the services. Conventionally, the supply chain is managed based on a supply of the products and the services by the manufacturers and a demand of the products and services by the consumers. While managing the supply chain, situations of overstock, stockout, late delivery, customer attrition, increase in costs of products, and other inefficient services may arise when demand and supply are disproportionate. The retailers and the distributors need to avoid such situations by synchronizing the two factors of demand and supply. Thus, the two factors need to be synchronized by forecasting an approximate demand of products and the services based upon certain analysis.

### SUMMARY

Disclosed are systems and methods for processing posts retrieved from social media to improve performance of a supply chain of products and services and the aspects are further described below in the detailed description. This summary is not intended to limit the scope of the claimed subject matter.

In one implementation, a method processing posts retrieved from social media to improve performance of a supply chain of products and services is disclosed. The method may include retrieving posts of users from the social media. The posts may be associated with a pre-defined product or service. The method may include classifying the posts into a plurality of categories based upon a learning technique. The method may further include determining an opinion of the users based upon the classified posts. The opinion of the users may be determined using learning techniques. The opinion of the users may be determined to be any one of a neutral opinion, a positive opinion, a negative opinion, or a combination thereof. The method may further include calculating latent variables using the classified posts and the opinion of the users. The latent variables may be calculated by using integrating techniques. The method may also include calculating modified Key Performance Indicators (KPI's) of a supply chain based upon existing KPI's of the supply chain, the opinion of the users, and the latent variables. The modified KPI's may be calculated using the learning techniques. The method may further include managing supply chain enablers of the products and the services based on the modified KPI's. Thus, the posts retrieved from social media may be processed to improve performance of a supply chain of products and services, in an above described manner.

In one implementation, a system for processing posts retrieved from social media to improve performance of a supply chain of products and services is disclosed. The system includes a processor and a memory coupled to the processor for executing programmed instructions stored in the memory. The processor may retrieve posts of users from the social media. The posts may be associated with a pre-defined product or service. The processor may further classify the posts into a plurality of categories based upon a learning technique. The processor may further determine an opinion of the users based upon the classified posts. The opinion of the users may be determined using learning techniques. The opinion of the users may be determined as one of a neutral opinion, a positive opinion, or a negative opinion. The processor may further calculate latent variables using the classified posts and the opinion of the users. The latent variables may be calculated by using integrating techniques. The processor may further calculate modified Key Performance Indicators (KPI's) of a supply chain based upon existing KPI's of the supply chain, the opinion of the users, and the latent variables. The modified KPI's may be calculated using the learning techniques. The processor may further manage supply chain enablers of the products and the services based on the modified KPI's. Thus, the posts retrieved from social media may be processed to improve performance of a supply chain of products and services, in an above described manner.

In one implementation, a non-transitory computer readable medium embodying a program executable in a computing device for processing posts retrieved from social media to improve performance of a supply chain of products and services is disclosed. The program may include a program code for retrieving posts of users from the social media. The posts may be associated with a pre-defined product or service. The program may further include a program code for classifying the posts into a plurality of categories based upon a learning technique. The program may further include a program code for determining an opinion of the users based upon the classified posts. The opinion of the users may be determined using learning techniques. The opinion of the users may be determined to be any one of a neutral opinion, a positive opinion, a negative opinion, or a combination thereof. The program may further include a program code for calculating latent variables using the classified posts and the opinion of the users. The latent variables may be calculated by using an integrating technique. The program may further include a program code for calculating modified Key Performance Indicators (KPI's) of a supply chain based upon existing KPI's of the supply chain, the opinion of the users, and the latent variables. The modified KPI's may be calculated using the learning techniques. The program may further include a program code for managing supply chain enablers based on the modified KPI's. Thus, the posts retrieved from social media may be processed to improve performance of a supply chain of products and services, in an above described manner.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for processing posts retrieved from social media to improve performance of a supply chain of products and services, in accordance with an embodiment of the present subject matter.

FIG. 2 illustrates a graphical representation of a safety stock planning determined by the system, in accordance with an embodiment of the present subject matter.

FIG. 3 shows a flowchart illustrating a method for processing posts retrieved from social media to improve performance of a supply chain of products and services, in accordance with an embodiment of the present subject matter.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings. Disclosed are systems and methods for processing posts retrieved from social media to improve performance of a supply chain of products and services. The system may retrieve posts of the users from the social media. The social media may include various social networking websites and discussion forums. The system may classify the posts into a plurality of categories for identifying relevant posts. The posts may be classified based upon a learning technique. For an example, the learning technique may include Naive Bayes algorithm or a derivative thereof. Post classification, the system may determine an opinion of the users based upon the classified posts. The system may determine the opinion of the user by using learning techniques. The opinion of the users may be determined as one of a neutral opinion, a positive opinion, or a negative opinion. The system may calculate latent variables using the classified posts and the opinion of the users. The system may calculate the latent variables by using integrated techniques. For an example, an integrated technique like item response theory may be used for calculating the latent variables.

Further, the system may calculate modified Key Performance Indicators (KPI's) of a supply chain based upon existing KPI's of the supply chain, the classified posts, the opinion of the users, and the latent variables. The classified posts and the opinion of the users are derived from the social media. The system may calculate the modified KPI's using the learning techniques. The learning techniques used for calculating the modified KPI's may comprise a random forest regression technique, a Support Vector Machine (SVM) model, and a linear regression technique. Multiple learning techniques may be used for calculating the modified KPI's, and the modified KPI's having optimum values may be selected. Further, the system may manage supply chain enablers of the products and the services based on the modified KPI's. Thus, the system may process the posts retrieved from social media to improve performance of a supply chain of products and services, in an above described manner.

While aspects of the described systems and methods for processing posts retrieved from social media to improve performance of a supply chain of products and services may be implemented in any number of different computing systems, environments, and/or configurations, the embodiments are described in the context of the following exemplary system.

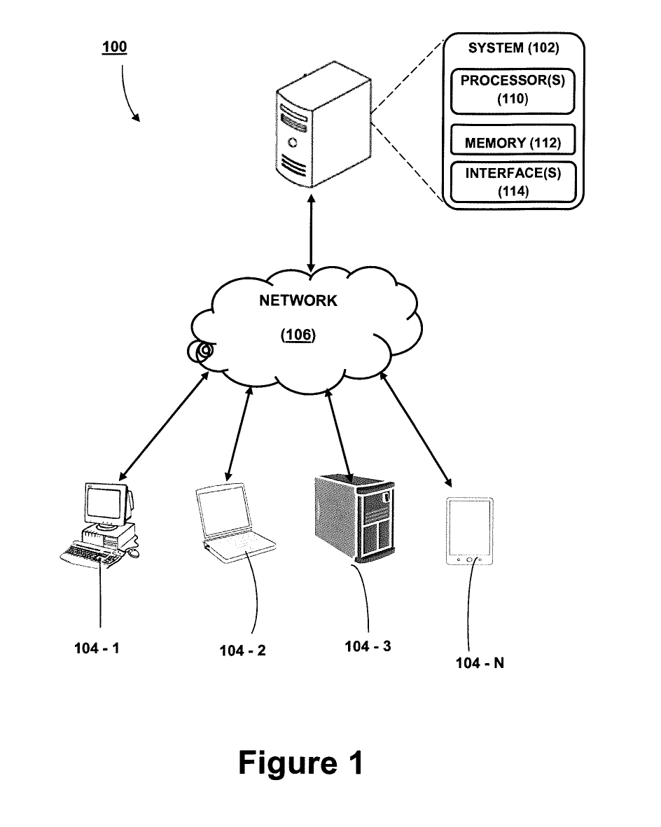

Referring now to FIG. 1, the system 102 for processing posts retrieved from social media to improve performance of a supply chain of products and services is shown, in accordance with an embodiment of the present subject matter. Although the present subject matter is explained considering that the system 102 is implemented on a computer, it may be understood that the system 102 may also be implemented in a variety of computing systems including but not limited to, a smart phone, a tablet, a notepad, a personal digital assistant, a handheld device, a laptop computer, a notebook, a workstation, a mainframe computer, a server, and a network server (e.g., 104-1, 104-2, 104-3, 104-N).

In one embodiment, as illustrated using FIG. 1, the system 102 may include at least one processor 110, a memory 112, and input/output (I/O) interfaces 114. Further, the at least one processor 110 may be implemented as one or more microprocessors, microcomputers, microcontrollers, digital signal processors, central processing units, state machines, logic circuitries, and/or any devices that manipulate signals based on operational instructions. Among other capabilities, the at least one processor 110 is configured to fetch and execute computer-readable instructions stored in the memory 112.

The I/O interfaces 114 may include a variety of software and hardware interfaces, for example, a web interface, a graphical user interface, and the like. The I/O interfaces 114 may allow the system 102 to interact with a user directly. Further, the I/O interfaces 114 may enable the system 102 to communicate with other computing devices, such as web servers and external data servers (not shown). The I/O interfaces 114 can facilitate multiple communications within a wide variety of networks and protocol types, including wired networks, for example, LAN, cable, etc., and wireless networks, such as WLAN, cellular, or satellite.

The memory 112 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, the system 102 may retrieve posts of users using the social media. The system 102 may retrieve the posts from social networking websites like Facebook™, Twitter™, Google plus™, LinkedIn™ and pinterest™. The system 102 may also retrieve the posts from e-commerce websites like Amazon™, Flipkart™, Jabong™, Myntra™, and Snapdeal™. Further, the system 102 may be programmed to retrieve the posts from new social media and discussion forums coming into existence. The posts may include tweets, comments, reviews, or any combination thereof posted by the users about products and services. The products and the services may already be pre-defined by an administrator.

For an example, the pre-defined product may be a Motorola™ product. In a case, the Motorola™ product may be a Moto E™ mobile handset. The mobile handset may be available for sale on at least one of the e-commerce website. For an example, the Moto E™ mobile handset may be available for sale on Flipkart™. Thus, the posts related to the Moto E™ mobile handset may be collected from Flipkart™. In a case, the system 102 may use Rcurl for collecting the posts. Rcurl is a crawler package providing Hyper Text Transfer Protocol (HTTP) facilities. Rcurl may use entry points getURL( ) and getURLContent( ) for collecting the posts. Further, the posts related to the Moto E™ mobile handset may also be fetched by the system 102 from Twitter™ and Facebook™. The system 102 may use TwitteR as the crawler package for fetching the posts from Twitter™ and Rfacebook as the crawler package for fetching the posts from Facebook™. In one case, the posts may be collected by the system 102 for a limited period of time.

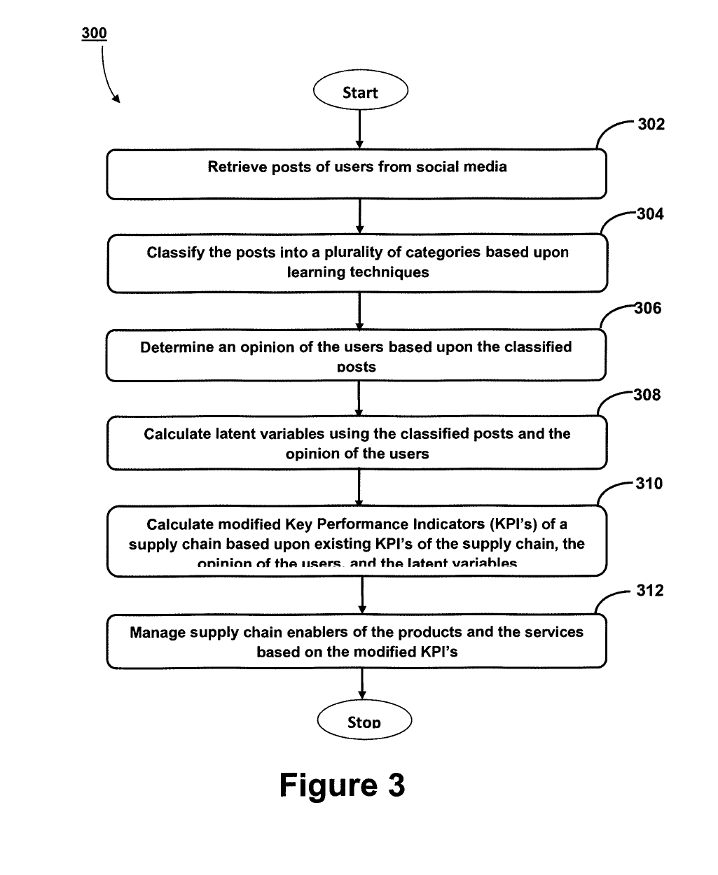

In one embodiment, the system 102 may process the posts of the users for removing Uniform Resource Locators (URL's), stop words, e-mail ID's, numbers, control spaces, special characters, punctuations, and business specific keywords. In certain aspects, the system 102 may use R programming language for processing the posts, and converting the posts into a term document matrix. R is used as a shorthand operator for the R programming language. R is a well known programming language for statistical computing of data and visualizing graphical analysis of the computed data. Post processing, the system 102 may convert the posts into the term document matrix. The term document matrix may represent a mathematical matrix having rows and columns. The rows may represent words present in the posts and the columns may represent documents. The documents may refer to the posts of the users or tweets of the users. Thus, the term document matrix may represent frequency of words present in the posts. FIG. 3 illustrates the term document matrix created by the system 102.

Post preparing the term document matrix, the system 102 may classify data of the term document matrix into a plurality of categories based upon a learning technique. In one embodiment, Naive Bayes technique may be used for classifying the posts. The posts may be classified for identifying relevant posts and discarding irrelevant posts present on the social media. For an example, a few of the users may post related to a stock out condition of the Moto E™ mobile handset on Twitter™ while the rest of the users may post unrelated to the stock out condition. The system 102 may then classify the posts into two categories. The two categories may include talking about stock out and not talking about stock out.

A table illustrated below as an example mentions two posts of the users and the category to which the posts relate to.

| Post | Category |
|---|---|
| MotoE ™ is back in stock on Flipkart ™, | Talking about stock out |
| continuing the trend of the handset being | |
| available for a short while every week | |
| MotoE ™is a cheap smart phone worth | Not talking about stock out |
| buying | |

Post classification, the system 102 may determine an opinion of the users based upon the classified posts. The opinion of the users may also be understood as a sentiment, reaction or response of the users. The system 102 may determine the opinion of the users by using learning techniques. Supervised learning techniques and unsupervised learning techniques may be used for determining the opinion of the users. For an example, the system 102 may use the Naive Bayes algorithm/technique for determining the opinion of the users. The Naive Bayes technique uses a probabilistic approach by employing Bayes theorem for determining the opinion of the users. Further, the system 102 may include a seed word dictionary stored in the memory 112. The seed word dictionary may include keywords stored against corresponding opinions. The system 102 may extract the keywords from the classified posts of the users. The system 102 may match the extracted keywords with the keywords present in the seed word dictionary and may thus identify the opinion corresponding to the keyword. The system 102 may determine a closeness of the keywords by using the Naive Bayes technique. Thus, the system 102 may identify the opinion of the users by using the Naive Bayes technique and the seed word dictionary.

In one case, the opinion of the users talking about the stockout may be determined. The opinion of the users may be determined by the system 102 as one of a neutral opinion, a positive opinion, or a negative opinion. In one embodiment, a program code in R programming language for applying the Naive Bayes technique on the classified data may be as mentioned below.

A table illustrated below as an example mentions three posts of the users and the opinion of the users determined using the posts

| Post | Opinion |
|---|---|
| A cheap smartphone worth buying | Neutral |
| Moto E ™ is back in stock on Flipkart ™, | Positive |
| continuing the trend of the handset being | |
| available for a short while every week | |
| Moto E ™ again out of stock on Flipkart ™, | Negative |
| the hottest budget phone in the market | |

In one embodiment, the system 102 may calculate latent variables after determining the opinion of the users. The system 102 may calculate the latent variables using the classified posts and the opinion of the users. The system 102 may calculate the latent variables by using integrating techniques. For an example, an integrating technique like item response theory may be used. The item response theory may help the system 102 to quantify the opinion of the users for the stock out condition. The item response theory may derive probability of each response as a function of the latent trait and item parameters. The item response theory may be used for calculating underlying trait of variables. The item response theory may help in determining a significance of the variables.

A table illustrated below as an example mentions categories of the posts, opinion of the users, and the latent variables calculated using the categories of the posts and the opinion of the users.

| | | Latent |
|---|---|---|
| Category | Opinion | Variable |
| Talking about stock out | Positive | 1.000 |
| Not talking about Stock out | Neutral | 0.541 |
| Talking about stock out | Negative | 0.118 |

In one embodiment, the system 102 may calculate modified Key Performance Indicators (KPI's) of the supply chain upon calculating the latent variables. The modified KPI's may include a cycle service level, a lead time demand, a safety stock, a fill rate, a Reorder Point (ROP), and a number of days in stock. The below mentioned table lists the KPI's along with a description of the KPI's.

| Key Performance | |
|---|---|
| Indicators (KPI's) | Definition |
| Fill Rate (FR) | A fraction of demand of a product |
| | satisfied from a product in an inventory |
| Cycle Service Level (CSL) | The fraction of replenishment cycles that |
| | ends by meeting a demand of the users |
| Lead Time (LT) | Time taken to place an order and recieve |
| | the product |
| Reorder Point (ROP) | Inventory level of a product and the |
| | service signalling the need for placement |
| | of a replenishment order |
| Days in Stock | Expresing ROP inventory in a number of |
| | days |

The system 102 may calculate the modified KPI's based upon existing KPI's of the supply chain, the opinion of the users, and the latent variables. Thus, the following relations may be derived for calculating the modified KPI's of the supply chain.

Modified KPI's of supply chain=f (Existing KPI's of supply chain, data retrieved from posts of users)

=f (Existing KPI's of supply chain, social media input)

Further, the system 102 may calculate the modified KPI's using the learning techniques. The learning techniques used for calculating the modified KPI's may include a random forest regression technique, a Support Vector Machine (SVM) model, and a linear regression technique. In one case, the system 102 may use the linear regression technique when a relation between the latent variables is linear in nature. Conversely, the system 102 may use the random forest regression technique and the SVM model while the relation between the latent variables is not linear. The random forest regression technique may be used to predict an expected service level by using an existing service level and a score indicating social media data. The score indicating the social media data may be derived from the posts of the users. The social media data score and the current service level may used as inputs for predicting an expected service level.

Post employing the random forest regression technique, a predicted service level may be derived by the system 102. For an example, a table shown below illustrates the predicted service level values derived by the system 102 when employing the random forest regression technique.

| Social media | Current | Expected | Predicted |
|---|---|---|---|
| data score | service level | service level | service level |
| 0.391217 | 91 | 91 | 91.15916 |
| 0.034303 | 95 | 95 | 95.25742 |
| 0.473525 | 94 | 94 | 93.9509 |
| 0.412732 | 93 | 93 | 93.04969 |
| 0.953398 | 96 | 98 | 97.8648 |
| 0.136204 | 95 | 95 | 95.27872 |
| 0.859157 | 97 | 99 | 98.62855 |
| 0.051363 | 94 | 94 | 93.94555 |
| 0.970794 | 95 | 97 | 96.95159 |
| 0.385784 | 97 | 97 | 96.86804 |

A table shown below illustrates the predicted service level values derived by the system 102 when employing the linear regression technique on a similar input data used in case of the random forest technique.

| Social media | Current | Expected | Predicted |
|---|---|---|---|
| data score | service level | service level | service level |
| 0.391217 | 91 | 91 | 91.48304 |
| 0.034303 | 95 | 95 | 94.50691 |
| 0.473525 | 94 | 94 | 94.61423 |
| 0.412732 | 93 | 93 | 93.48822 |
| 0.953398 | 96 | 98 | 97.74999 |
| 0.136204 | 95 | 95 | 94.75825 |
| 0.859157 | 97 | 99 | 98.4936 |
| 0.051363 | 94 | 94 | 93.57293 |
| 0.970794 | 95 | 97 | 96.81684 |
| 0.385784 | 97 | 97 | 97.32598 |

The table shown below illustrates the predicted service level values derived by the system 102 when employing a SVM model on a similar input data used by the forest regression technique and the linear regression technique.

| Social media | Current | Expected | Predicted |
|---|---|---|---|
| data score | service level | service level | service level |
| 0.391217 | 91 | 91 | 90.83489 |
| 0.034303 | 95 | 95 | 95.24604 |
| 0.473525 | 94 | 94 | 94.37911 |
| 0.412732 | 93 | 93 | 93.17096 |
| 0.953398 | 96 | 98 | 98.07532 |
| 0.136204 | 95 | 95 | 95.17205 |
| 0.859157 | 97 | 99 | 98.50381 |
| 0.051363 | 94 | 94 | 94.21769 |
| 0.970794 | 95 | 97 | 97.17465 |
| 0.385784 | 97 | 97 | 97.07379 |

The system 102 may use at least one learning technique selected from the random forest regression technique, the linear regression technique, and the SVM model based on an optimum Mean Absolute Percentage Error (MAPE) value, for calculating the modified KPI's. The MAPE value may indicate a deviation of predicted variables from actual values of variables. Further, the system may use multiple learning techniques for calculating the modified KPI's. The modified KPI's having an optimum MAPE value may then be selected by the system 102.

Post calculating the modified KPI's, the system 102 may manage supply chain enablers of the products and the services based on the modified KPI's. The supply chain enablers may include a demand forecasting, an inventory optimization, a safety stock, a markdown, a service level, a facility location and allocation, a competitive performance, and a new product. The supply chain enablers may then improvise the supply chain of products and services. Thus, the modified KPI's like the cycle service level, the lead time demand, the safety stock, the fill rate, the Reorder Point (ROP), and the number of days in stock may be improved based on the data of the social media.

The effect of the modified KPI's on the supply chain is explained henceforth in the form of an example. The safety stock may refer to an extra stock that may be maintained in order to mitigate a risk of stock out occurring due to uncertainties in supply and demand of the product and the services. The tables shown below illustrate a relation between the modified KPI's and the safety stock. For example, when a value of the cycle service level is 0.95, values of the service stock and the modified KPI's are,

### For Cycle Service Level=0.95

| Output | Values |
|---|---|
| Safety stock | 1693 |
| Lead time demand | 6000 |
| Reorder Point (ROP) | 7693 |
| Number of days in stock | 7.69 |

In another example, when a value of the fill rate is 0.98, values of the service stock and the modified KPI's are,

### For Fill Rate=0.98

| Output | Values |
|---|---|
| Safety stock | 22 |
| Lead time demand | 6000 |
| Reorder Point (ROP) | 6022 |
| Number of days in stock | 6.02 |

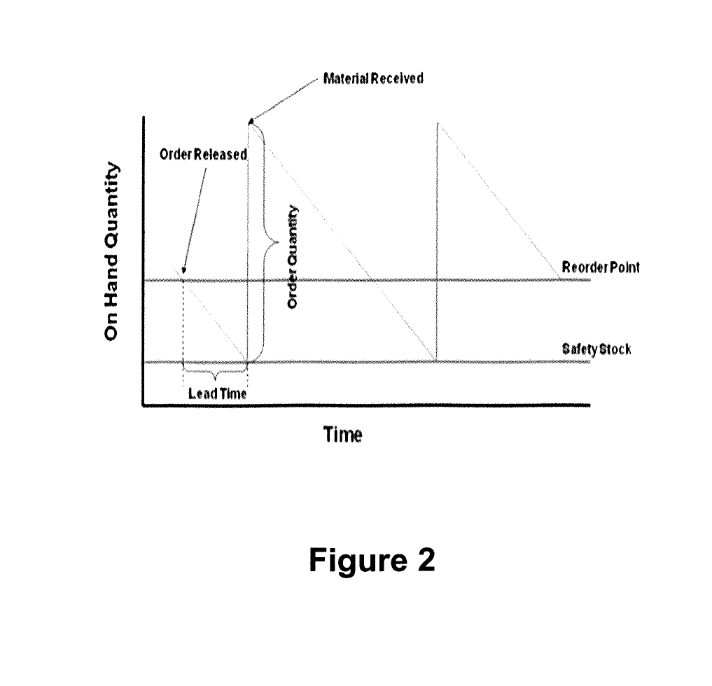

FIG. 2 illustrates a graphical representation of safety stock planning determined by the system 102. Thus, the system 102 may process the posts retrieved from social media to improve performance of the supply chain of products and services in an above described manner.

Referring now to FIG. 3, the method for processing posts retrieved from social media to improve performance of a supply chain of products and services is described, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, posts of users may be retrieved from the social media. The posts may be associated with a pre-defined product or service. In one implementation, the posts may be retrieved by the processor 202.

At block 304, the posts may be classified into a plurality of categories based upon a learning technique. The learning technique like Naive Bayes algorithm may be used for classifying the posts. In one implementation, the posts may be classified by the processor 202.

At block 306, an opinion of the users may be determined based upon the classified posts. The opinion of the users may be determined using the learning technique. The opinion of the users may be determined as one of a neutral opinion, a positive opinion, or a negative opinion. In one implementation, the opinion of the users may be determined by the processor 202.

At block 308, latent variables may be calculated using the classified posts and the opinion of the users. The latent variables may be calculated by using integration techniques. An integration technique like item response theory may be used for calculating the latent variables. In one implementation, the latent variables may be calculated by the processor 202.

At block 310, modified Key Performance Indicators (KPI's) of a supply chain may be calculated based upon existing KPI's of the supply chain, the opinion of the users, and the latent variables. The modified KPI's may be calculated using the learning techniques. The learning techniques may comprise a random forest regression technique, a Support Vector Machine (SVM) model, and a linear regression technique. In one implementation, the modified Key Performance Indicators (KPI's) of the supply chain may be calculated by the processor 202.

At block 312, supply chain enablers of the products and the services may be managed based on the modified KPI's. In one implementation, the supply chain enablers of the products and the services may be managed by the processor 202.

Although implementations for methods and systems for processing posts retrieved from social media to improve performance of a supply chain of products and services have been described in language specific to structural features and/or methods, it is to be understood that the appended claims are not necessarily limited to the specific features or methods described. Rather, the specific features and methods are disclosed as examples of implementations for processing posts retrieved from social media to improve performance of a supply chain of products and services.

We claim:

1. A method for processing posts retrieved from social media to improve performance of a supply chain of products and services, the method comprising:
retrieving, by a processor, posts of users from the social media, wherein the posts are associated with a pre-defined product or service;
classifying, by the processor, the posts into a plurality of categories based upon a learning technique;
determining, by the processor, an opinion of the users based upon the classified posts, wherein the opinion of the users is determined using learning techniques, and wherein the opinion of the users is determined as one of a neutral opinion, a positive opinion, or a negative opinion;
calculating, by the processor, latent variables using the classified posts and the opinion of the users, wherein the latent variables are calculated by using integrating techniques;
calculating, by the processor, modified Key Performance Indicators (KPI's) of a supply chain based upon existing KPI's of the supply chain, the opinion of the users, and the latent variables, wherein the modified KPI's are calculated using the learning techniques; and
managing, by the processor, supply chain enablers of the products and the services based on the modified KPI's, thereby processing posts retrieved from social media to improve performance of a supply chain of products and services.

2. The method of claim 1, further comprising processing the posts of the users for removing Uniform Resource Locators (URL's), stop words, e-mail ID's, numbers, control spaces, special characters, punctuations, and business specific keywords.

3. The method of claim 1, wherein the learning techniques comprise a Random Forest Regression technique, a Linear Regression technique, an Item Response Theory (IRT), a Support Vector Machine (SVM), a Naive Bayes algorithm, or any combination thereof.

4. The method of claim 1, wherein the modified KPI's comprise a cycle service level, a lead time demand, a safety stock, a fill rate, a Reorder Point (ROP), a number of days in stock, or any combination thereof.

5. The method of claim 1, wherein the supply chain enablers comprise demand forecasting, inventory optimization, safety stock, markdown, service level, facility location and allocation, competitive performance, a new product, or any combination thereof.

6. A system for processing posts retrieved from social media to improve performance of a supply chain of products and services, the system comprising:
a processor; and
a memory coupled to the processor, wherein the processor is capable for executing programmed instructions stored in the memory to:
retrieve posts of users from the social media, wherein the posts are associated with a pre-defined product or service;
classify the posts into a plurality of categories based upon a learning technique;
determine an opinion of the users based upon the classified posts, wherein the opinion of the users is determined using learning techniques, and wherein the opinion of the users is determined as one of a neutral opinion, a positive opinion, or a negative opinion;
calculate latent variables using the classified posts and the opinion of the users, wherein the latent variables are calculated by using integrating techniques;
calculate modified Key Performance Indicators (KPI's) of a supply chain based upon existing KPI's of the supply chain, the opinion of the users, and the latent variables, wherein the modified KPI's are calculated using the learning techniques; and
manage supply chain enablers of the products and the services based on the modified KPI's, thereby processing posts retrieved from social media to improve performance of a supply chain of products and services.

7. The system of claim 6, further comprising processing the posts of the users for removing Uniform Resource Locators (URL's), stop words, e-mail ID's, numbers, control spaces, special characters, punctuations, business specific keywords, or any combination thereof.

8. The system of claim 6, wherein the learning techniques comprises a Random Forest Regression technique, a Linear Regression technique, an Item Response Theory (IRT), a Support Vector Machine (SVM), a Naive Bayes algorithm, or any combination thereof.

9. The system of claim 6, wherein the modified KPI's comprise a cycle service level, a lead time demand, a safety stock, a fill rate, a Reorder Point (ROP), a number of days in stock, or any combination thereof.

10. The system of claim 6, wherein the supply chain enablers comprise demand forecasting, inventory optimization, safety stock, markdown, service level, facility location and allocation, competitive performance, a new product, or any combination thereof.

11. A non-transitory computer readable medium embodying a program executable in a computing device for processing posts retrieved from social media to improve performance of a supply chain of products and services, the program comprising:
a program code for retrieving posts of users from the social media, wherein the posts are associated with a pre-defined product or service;
a program code for classifying the posts into a plurality of categories based upon a learning technique;
a program code for determining an opinion of the users based upon the classified posts, wherein the opinion of the users is determined using learning techniques, and wherein the opinion of the users is determined as one of a neutral opinion, a positive opinion, or a negative opinion;
a program code for calculating latent variables using the classified posts and the opinion of the users, wherein the latent variables are calculated by using integrating techniques;
a program code for calculating modified Key Performance Indicators (KPI's) of a supply chain based upon existing KPI's of the supply chain, the opinion of the users, and the latent variables, wherein the modified KPI's are calculated using the learning techniques; and
a program code managing supply chain enablers of the products and the services based on the modified KPI's, thereby processing posts retrieved from social media to improve performance of a supply chain of products and services.
